(19) United States
(12) Patent Application Publication
(10) Pub. No.: US 2022/0229767 A1
(43) Pub. Date: Jul. 21, 2022

(54) TEST SCRIPT GENERATION APPARATUS, TEST SCRIPT GENERATION METHOD AND PROGRAM

(71) Applicant: NIPPON TELEGRAPH AND TELEPHONE CORPORATION, Tokyo (JP)

(72) Inventors: Toshiyuki KURABAYASHI, Tokyo (JP); Haruto TANNO, Tokyo (JP); Yu ADACHI, Tokyo (JP); Hiroyuki KIRINUKI, Tokyo (JP); Yu YOSHIMURA, Tokyo (JP)

(73) Assignee: NIPPON TELEGRAPH AND TELEPHONE CORPORATION, Tokyo (JP)

(21) Appl. No.: 17/615,057

(22) PCT Filed: May 30, 2019
(86) PCT No.: PCT/JP2019/021551

§ 371 Date: Nov. 29, 2021

(51) Int. Cl. G06F 11/36

(52) U.S. Cl. CPC G06F 11/3684; G06F 11/3664

(57) ABSTRACT

The test script generation device includes: an identifying unit that identifies a path through a screen specified by a user in a screen transition diagram; and a generation unit that generates a test script based on a combination of a value input to a transition source screen in the generation of the screen transition diagram for a transition included in the path and an operation related to the transition, thereby streamlining a test of application that provides functionality by the screen transition.

### TECHNICAL FIELD

The present invention relates to a test script generation device, a test script generation method, and a program.

### BACKGROUND ART

In order to promptly provide services that meet diverse needs of consumers there has been, in recent years, an increase in the development style of developing software in short cycles and frequently releasing services. With services being provided in short cycles, there has also been an increase in the frequency of software testing to confirm that software is normally operated. In the software testing, function tests are performed to confirm whether a web application under test operates as intended by a designer. However, the function tests may take a huge amount of time for a test made by combining a plurality of functions (hereinafter, referred to as a “scenario test”).

At this point, a collection of one or more screens is defined as a function. The scenario test takes the time not only because a lot of contents are executed in one test due to a test combined a plurality of functions, but also because interaction from a client side requires operation with human intervention such as click operation of a link or a button on a screen or input of an appropriate value in an input form. Because these operations are repeatedly performed on all screens, it takes a huge amount of time, and thus labor saving is required.

As a method for reducing time required for the test, a method for automatically executing the test by producing a test case as a script is widely known (Non Patent Literature 1). However, creating a test script also takes time, and it is generally said that the effect of task time does not appear unless automated testing using a created test script is performed three times or more. In addition, because a created test script cannot be used when a change is applied to an existing function, it is necessary to create a test script every time a specification is changed.

In order to solve such problems, there is a reverse-based test script automated generation technique (hereinafter, referred to as a “reverse-based test technique”) that restores specification information by analyzing a web application to be tested and automatically generates the test script from the restored specification information (Non Patent Literature 2).

### CITATION LIST

### Non Patent Literature

Non Patent Literature 1: “Selenium IDE”, [online], internet <URL: https://addons.mozilla.org/ja/firefox/addon/selenium-ide/>
Non Patent Literature 2: “Method of Automatically Generating Test Script in Test Accompanied by Screen Operation”, Toshiyuki Kurabayashi, Muneyoshi Iyama, Hiroyuki Kirinuki, and Haruto Tanno, Software Engineering Symposium 2017 pp. 260-264, September 2017

### SUMMARY OF THE INVENTION

### Technical Problem

In the reverse-based test technique, crawling is performed such that the screen transition under test is covered, and operations in performing the crawling are output as the script, so that a test script that performs the test covering screen transitions can be automatically generated. It is theoretically possible to automatically generate the test script for the scenario test by applying the reverse-based test technique to perform the crawling so as to cover a combination of functions.

However, generating the test script by performing crawling to cover a combination of functions is not practical because it is too time-consuming. For example, there are 27,000 patterns for combining 3 functions chosen from 30 functions. As the pattern increases explosively depending on the number of functions and the number of combinations, it is not efficient to apply the reverse-based test technique as is to the scenario test.

In view of the foregoing, an object of the present invention is to streamline the application test that provides the function by the screen transition.

### Means for Solving the Problem

In order to solve the above problem, a test script generation device includes: an identifying unit configured to identify a path through a screen specified by a user in a screen transition diagram; and a generation unit configured to generate a test script based on a combination of a value input to a transition source screen in generation of the screen transition diagram for a transition included in the path and an operation related to the transition.

### Effects of the Invention

Testing of applications that provide functionality through screen transitions can be streamlined.

### BRIEF DESCRIPTION OF DRAWINGS

FIG. 1 is a diagram illustrating a hardware configuration example of a test script generation device 10 according to an embodiment of the present invention.

FIG. 2 is a diagram illustrating a functional configuration example of the test script generation device 10 according to the embodiment of the present invention.

FIG. 3 is a flowchart illustrating an example of a processing procedure executed by the test script generation device 10.

FIG. 4 is a diagram illustrating an example of a screen transition diagram in the embodiment of the present invention.

FIG. 5 is a diagram illustrating an example of a specification of a screen and a transition along a scenario to be tested.

FIG. 6 is a flowchart illustrating an example of a processing procedure of a screen transition diagram generation processing.

### DESCRIPTION OF EMBODIMENTS

An embodiment of the present disclosure will be described below with reference to the drawings. In the embodiment, a user specifies a screen and a transition sequence that indicate a scenario (defined as a set of consecutive screens and transitions) to be tested for a Web application, and a test script implementing only the scenario is automatically generated with the reverse-based test technique, thereby automatically generating the test script of the scenario test within a real time. In this case, there are two technical problems.

Technical problem (1): How a user specifies what scenario to be tested?
Technical problem (2): How to generate the test script corresponding to the specified scenario?
Technical Problem (1) is solved by presenting a screen transition diagram obtained by restoring a specification to be tested using the reverse-based test technique disclosed in Non Patent Literature 2 to the user, and specifying the scenario to be tested through the screen transition diagram by the user.

Technical Problem (2) is solved by storing an input value and operation in each screen transition performed during the crawling in the reverse-based test technique, combining the input value and the operation in accordance with the specified scenario to create an operation row, and outputting the operation row as a test script.

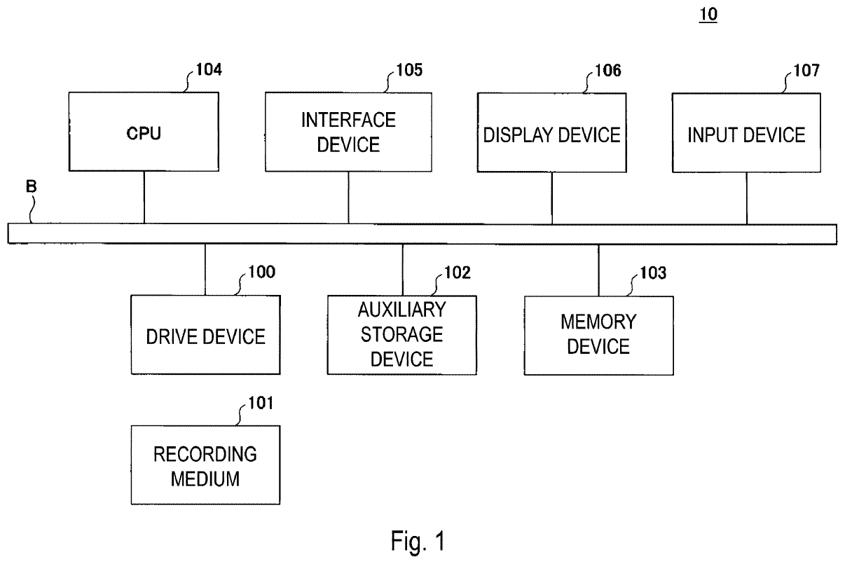

A test script generation device 10 that performs the above description will be described in detail below. FIG. 1 is a diagram illustrating a hardware configuration example of the test script generation device 10 according to an embodiment of the present invention. The test script generation device 10 of FIG. 1 includes a drive device 100, an auxiliary storage device 102, a memory device 103, a CPU 104, an interface device 105, a display device 106, and an input device 107, which are connected to each other through a bus B.

A program implementing processing in the test script generation device 10 is provided by a recording medium 101 such as a CD-ROM. When the recording medium 101 in which a program is stored is set in the drive device 100, the program is installed in the auxiliary storage device 102 from the recording medium 101 through the drive device 100. However, the program is not necessarily installed by the recording medium 101, and may be downloaded from another computer through a network. The auxiliary storage device 102 stores the installed program and stores necessary files, data, and the like.

When an instruction for starting a program is given, the memory device 103 reads the program from the auxiliary storage device 102 and stores the program. The CPU 104 implements a function relevant to the test script generation device 10 in accordance with the program stored in the memory device 103. The interface device 105 is used as an interface for connection to a network. The display device 106 displays a graphical user interface (GUI) or the like based on the program. The input device 107 is constituted by a keyboard, a mouse, and the like, and is used for inputting various operation instructions.

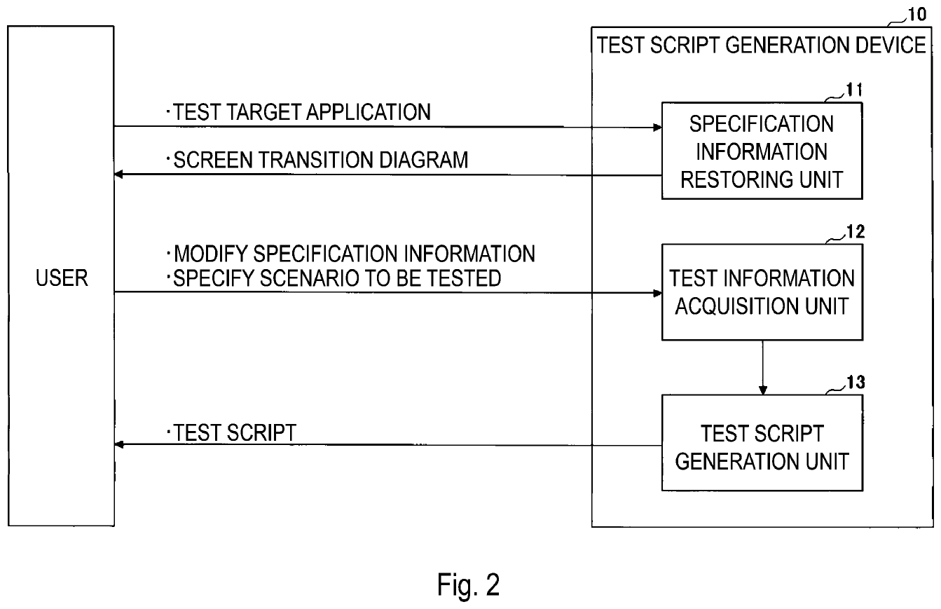

FIG. 2 is a diagram illustrating a functional configuration example of the test script generation device 10 according to the embodiment of the present invention. In FIG. 2, the test script generation device 10 includes a specification information restoring unit 11, a test information acquisition unit 12, and a test script generation unit 13. Each of these units is implemented by processing that at least one program installed in the test script generation device 10 causes the CPU 104 to execute.

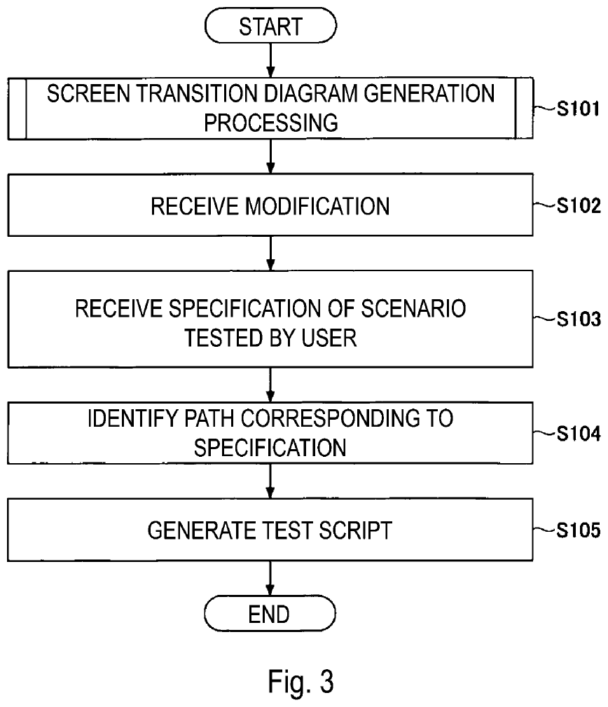

A processing procedure executed by the test script generation device 10 will be described below. FIG. 3 is a flowchart illustrating an example of a processing procedure executed by the test script generation device 10.

In step S101, the specification information restoring unit 11 restores specification information to an application to be tested (hereinafter, referred to as a “target application”), and generates a screen transition diagram. The generation of the screen transition diagram may be performed using known reverse-based test techniques (Non Patent Literature 2). For example, the generated screen transition diagram is displayed on the display device 106.

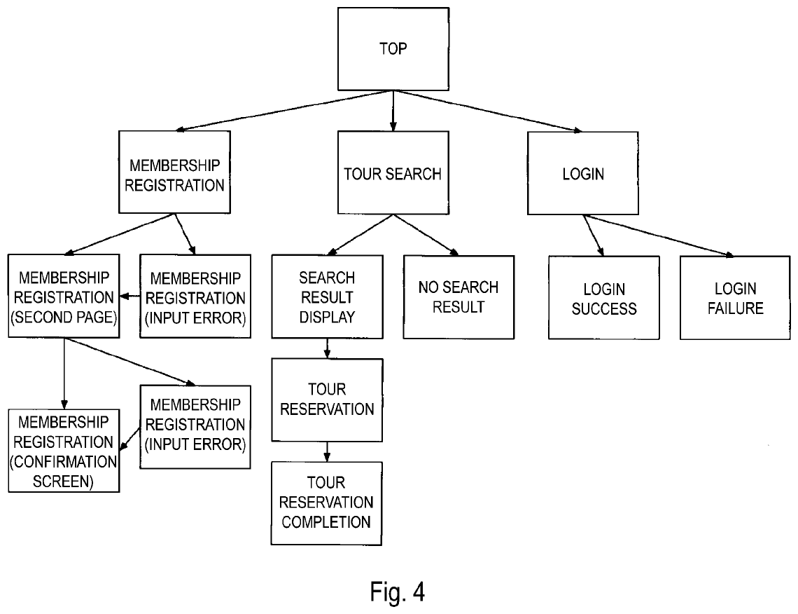

FIG. 4 is a diagram illustrating an example of the screen transition diagram according to the embodiment of the present invention. In the embodiment, the screen transition diagram in FIG. 4 is supposed to be a screen transition diagram that is restored for the target application. Each rectangle (each node) in the screen transition diagram shows the screen, and an arrow between the nodes indicates transition between screens and a direction of the transition. That is, an original side of the arrow corresponds to a transition source screen, and the leading side of the arrow corresponds to a transition destination screen.

The specification information restoring unit 11 stores an input value and operation information for each screen transition performed during the crawling for generating the screen transition diagram, for example, in the auxiliary storage device 102. The input value refers to the value entered with respect to the transition source screen. The operation information refers to information indicating an operation that triggers the screen transition. For example, in a login screen, values are entered into input forms of a user ID and a password, and then a login button is clicked. In this case, the information regarding each operation of inputting the values and clicking the login button is stored as the operation information, and the values entered into the input forms of the user ID and the password are stored as the input value set while associated with information indicating the transition performed in response to the operation (hereinafter, referred to as “transition information”). Hereinafter, an example of the operation information and input value set stored in association with the transition information for the transition from the login screen to successful login (transition from “login” to “login success” in FIG. 4).

### Operation Information

driver.findElement (By.id (“id of login ID input form”)).sendKeys (value 1);
driver.findElement (By.id (“id of password input form”)).sendKeys (value 2);
driver.find_element (:xpath, “xpath of login button”).click
Input value set
Value 1: abcd
Value 2: aaaa1234
Each of the operation information and the input value set is stored in association with the transition corresponding to the operation information and the input value set.

Subsequently, the test information acquisition unit 12 performs a modification of the information (operation information, input value set, and the like) stored in the screen transition diagram (FIG. 4) or step S101 (S102) according to the instruction of the user. However, in the case where the modification instruction is not entered by the user, the modification may not be performed. For example, when a test using not a normal account (user ID, password) used during the crawling but an administrator account is included in the scenario test that the user wants to perform, the login ID and password of the administrator account may be added to the input value set. In this case, the user may impart a name for each input value set so as to be distinguishable from each input value set. The input value set may be added by directly editing a file in which the operation information and the input value set are stored. As a result, the input value set will include a plurality of patterns as follows.

Input value set
[Normal account]
Value 1: abcd
Value 2: aaaa1234
[Administrator account]
Value 1: xxxyyyzzz
Value 2: xyz1111
Note that in the above description, the “normal account” is the name assigned to the first input value set and the “administrator account” is the name assigned to the second input value set.

Subsequently, the test information acquisition unit 12 receives the specification of the scenario to be tested by the user through the screen transition diagram (S103). The receipt of the specification is performed by selection of the screen included in the screen transition diagram. The transition may also be selected as well as the screen. However, not all screens and transitions constructing the scenario need to be specified, and some screens and transitions may be omitted. For example, in the embodiment, the scenario in which the user wants the test is supposed to be the following four patterns.

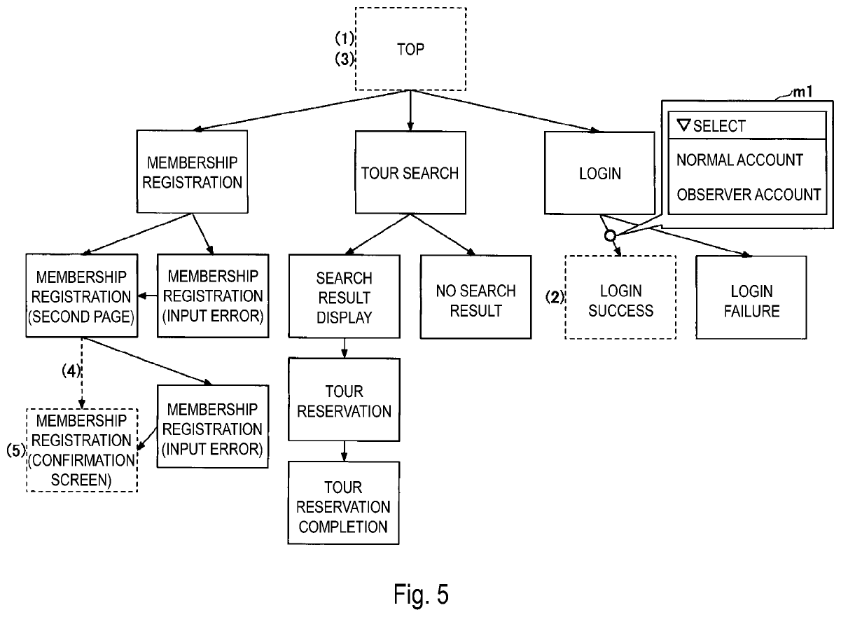

(a) Top→login→(login in normal account)→login success→TOP→membership registration→membership registration (second page)→membership registration (confirmation screen)
(b) Top→login→(login in administrator account)→login success→TOP→membership registration→membership registration (second page)→membership registration (confirmation screen)
(c) Top→login→(login in normal account)→login success→TOP→membership registration→membership registration (input error)→membership registration (second page)→membership registration (confirmation screen)
(d) Top→login→(login in administrator account)→login success→TOP→membership registration→membership registration (input error)→membership registration (second page)→membership registration (confirmation screen)
In the above description, the transition to top is included in the middle of the process, but the transition from the node (terminal screen) at the terminal end of the screen transition diagram to the top is omitted for convenience in FIG. 4. That is, in the embodiment, a screen transition of the target application is supposed to be configured such that the transition from the terminal screen to the top is enabled. Thus, the terminal screen refers to a screen in which only TOP is the screen of the transition destination in the target application. In this case, for example, the screen and transition may be specified as shown in FIG. 5. In FIG. 5, (1) to (5) illustrate order of specifications (click and the like), and the specified screen or transition is represented by the dashed line.

In step S103, the operation may be performed to enable only one input value set for a transition in which a plurality of input value sets are set. In this case, for example, when the transition is right-clicked in the screen transition diagram, a menu ml that includes a list of input value sets stored in association with the transition information of the transition is displayed as illustrated in FIG. 5. An example in which the menu ml includes the “normal account” and “administrator account” as an option is illustrated in FIG. 5. When only one option is selected by the user, the test information acquisition unit 12 only enables the selected set of input values from the list of input value sets stored in association with the transition information.

Subsequently, the test script generation unit 13 identifies all paths (scenarios) in the screen and transitions specified by the user (between the paths through (1) to (5) in FIG. 5) (S104). At this point, in a case where a discontinuous portion exists between the specified screen and transition, the test script generation unit 13 complements the path (scenario) of the discontinuous portion by automatically generating the discontinuous portion based on the screen transition diagram. For example, when the top screen is selected first in FIG. 4 and then the login successful screen is selected, a scenario of “Top→Login→Login success”, which is a scenario from the top screen to the login success screen, is automatically generated and added for user specification. When there are a plurality of input value sets while the specification does not exist (for example, in the case where no selection is made in the menu ml of FIG. 5), a scenario is generated for a pattern of all valid input value sets. Further, when there are multiple paths such as the membership registration screen from the Top screen, scenarios of all path patterns are generated.

Such complement will automatically generate all four pattern scenarios (a) to (d) to generate this test script, even if the specification as in FIG. 5 is made. Here, both options (input value sets) included in the menu ml are supposed to be valid. In this case, the test script generation unit 13 identifies one path between (1) to (2) in FIG. 5, but the test script generation unit 13 identifies two patterns because of two input values. On the other hand, the test script generation unit 13 identifies two paths between (3) to (5) in FIG. 5 because of branches from “membership registration” screen. Thus, the test script generation unit 13 identifies 2×2=4 paths (i.e., patterns). That is, the path through the screen or transition specified by the user is differentiated by the input value set in all the paths from the screen initially specified by the user (screen of (1) in FIG. 5) to the screen (screen of (5) in FIG. 5) finally specified by the user. This distinguishes and identifies each scenario (hereinafter, referred to as a “specified scenario”) specified by the user.

Subsequently, the test script generation unit 13 generates a test script that satisfies each specified scenario. Specifically, for each specified scenario, the test script generation unit 13 combines the input values and the operation information in each transition stored in step S101 to exhaustively generate an operation row implementing the specified scenario, and outputs the test script including the operation row (S105).

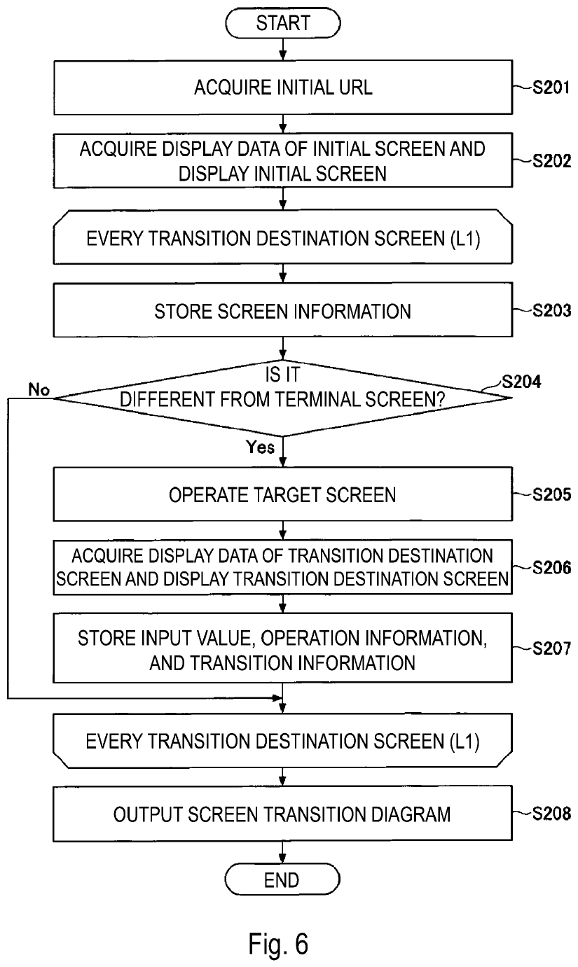

Subsequently, details of step S101 will be described. FIG. 6 is a flowchart illustrating an example of a processing procedure of the generation processing of screen transition diagram.

In step S201, the specification information restoring unit 11 acquires an initial uniform resource locator (URL) of a target application. The term “initial URL” refers to a URL for a screen serving as a starting point in screen transition of the target application. The initial URL may be input by a user at timing of step S201, or may previously be stored in the auxiliary storage device 102 or the like.

Next, the specification information restoring unit 11 acquires display data (such as HTML data) of an initial screen corresponding to the initial URL by accessing a target URL, and uses a Web browser to display the initial screen on the display device 106 based on the display data (S202). In the example of FIG. 5, the “TOP” screen corresponds to the initial screen.

Subsequently, the specification information restoring unit 11 executes loop processing L1 including steps S203 to S207 for each of all transition destination screens. Hereinafter, a screen which is a processing target in the loop processing L1 is referred to as a “target screen”. Initially, the initial screen becomes the target screen.

In step S203, the specification information restoring unit 11 stores screen information (HTML, title, identification information, and the like) of the target screen in the auxiliary storage device 102. Then, when the target screen is not a terminal screen (Yes at S204), steps S205 to S207 are performed.

In step S205, the specification information restoring unit 11 automatically operates the target screen to make the transition of the screen. At this time, in the case where the input of the value is required for the target screen, the input value is automatically generated using known technique (for example, Non Patent Literature 2). Subsequently, the specification information restoring unit 11 acquires the display data of the screen corresponding to the URL of the transition destination by accessing the URL, and uses the Web browser to display the screen on the display device 106 based on the display data (S206). Subsequently, the specification information restoring unit 11 stores the operation information indicating the operation in step S205, the input value set related to the operation, and transition information related to the transition performed in response to the operation in the auxiliary storage device 102. For example, the transition information is information that includes identification information of each screen of the transition source and the transition destination.

When the loop processing L1 is executed for all the transition destination screens, the specification information restoring unit 11 generates the screen transition diagram based on screen information, transition information, input value sets, and operation information stored for each screen or each transition, and outputs (displays) the screen transition diagram (S208).

As described above, according to the embodiment, the test script corresponding to the screen and the transition sequence specified by the user is automatically generated. In other words, the scenario that is subject to the automatically generated test script is limited to the scenario specified by the user. As a result, the test of application that provides the functionality through the screen transition can be streamlined.

The embodiment may be applied to an application other than the Web application as long as the application provides the function by the screen transition.

In the embodiment, the test script generation unit 13 is an example of the identifying unit and the generation unit. The test information acquisition unit 12 is an example of the receiving unit.

Although the embodiment of the present invention has been described above, the present invention is not limited to such specific embodiments, and can be modified and changed variously without departing from the scope of the invention described in the appended claims.

### REFERENCE SIGNS LIST

10 Test script generation device
11 Specification information restoring unit
12 Test information acquisition unit
13 Test script generation unit
100 Drive device
101 Recording medium
102 Auxiliary storage device
103 Memory device
104 CPU
105 Interface device
106 Display device
107 Input device
B Bus

1. A test script generation device comprising:
an identifier configured to identify a path through a screen specified by a user in a screen transition diagram; and
a generator configured to generate a test script based on a combination of a value input to a transition source screen in generation of the screen transition diagram for a transition included in the path and an operation related to the transition.

2. The test script generation device according to claim 1, wherein the identifier identifies the path through the transition when the transition is specified by a user.

3. The test script generation device according to claim 1, further comprising a receiver configured to receive a screen or transition specification through the screen transition diagram.

4. A computer-implemented method for generating a test script, the method comprising:
identifying, by an identifier, a path through a screen specified by a user in a screen transition diagram; and
generating, by a generator, a test script based on a combination of a value input to a transition source screen in generation of the screen transition diagram for a transition included in the path and an operation related to the transition.

5. The computer-implemented method according to claim 4, wherein, when a user specifies the transition, the identifier identifies the pass through the transition.

6. The computer-implemented method according to claim 4, the method further comprises:
receiving a screen or transition specification through the screen transition diagram.

7. A computer-readable non-transitory recording medium storing computer-executable program instructions that when executed by a processor cause a computer system to:
identify, by an identifier, a path through a screen specified by a user in a screen transition diagram; and
generate, by a generator, a test script based on a combination of a value input to a transition source screen in generation of the screen transition diagram for a transition included in the path and an operation related to the transition.

8. The test script generation device according to claim 1, wherein the identifier further configured to identify a discontinuous portion of the path, and wherein the generator further configured to automatically generate the discontinuous portion using the screen transition diagram.

9. The test script generation device according to claim 1, wherein,
when a plurality of input value sets associated with the transition source screen exist without selection by the user, the generator further configured to automatically generate a plurality of the test script using the plurality of input value sets.

10. The test script generation device according to claim 2, further comprising a receiver configured to receive a screen or transition specification through the screen transition diagram.

11. The computer-implemented method according to claim 4, wherein the identifier further configured to identify a discontinuous portion of the path, and wherein the generator further configured to automatically generate the discontinuous portion using the screen transition diagram.

12. The computer-implemented method according to claim 4, wherein,
when a plurality of input value sets associated with the transition source screen exist without selection by the user, the generator further configured to automatically generate a plurality of the test script using the plurality of input value sets.

13. The computer-implemented method according to claim 5, the method further comprises:
receiving a screen or transition specification through the screen transition diagram.

14. The computer-readable non-transitory recording medium of claim 7,
wherein, when a user specifies the transition, the identifier identifies the pass through the transition.

15. The computer-readable non-transitory recording medium of claim 7, the computer-executable program instructions when executed further causing the system to:
receive a screen or transition specification through the screen transition diagram.

16. The computer-readable non-transitory recording medium of claim 7,
wherein the identifier further configured to identify a discontinuous portion of the path, and wherein the generator further configured to automatically generate the discontinuous portion using the screen transition diagram.

17. The computer-readable non-transitory recording medium of claim 7, wherein,
when a plurality of input value sets associated with the transition source screen exist without selection by the user, the generator further configured to automatically generate a plurality of the test script using the plurality of input value sets.

18. The computer-implemented method according to claim 13, the method further comprises:
displaying a menu associated with the transition source screen on the screen transition diagram, the menu including a plurality of value input for the transition source screen for selection;
interactively receiving a menu selection of at least one of the plurality of the value input to the transition source screen; and
generating the test script using the menu selection.

19. The computer-readable non-transitory recording medium of claim 14, the computer-executable program instructions when executed further causing the system to:
receive a screen or transition specification through the screen transition diagram.

20. The computer-readable non-transitory recording medium of claim 19,
the computer-executable program instructions when executed further causing the system to:
display a menu associated with the transition source screen on the screen transition diagram, the menu including a plurality of value input for the transition source screen for selection;
interactively receive a menu selection of at least one of the plurality of the value input to the transition source screen; and
generate the test script using the menu selection.
